(19) United States
(12) Patent Application Publication
(10) Pub. No.: US 2025/0259053 A1
(43) Pub. Date: Aug. 14, 2025

(54) SYSTEMS AND METHODS FOR TRAINING MACHINE LEARNING MODELS USING DIFFERENTIATION

(71) Applicant: Capital One Services, LLC, McLean, VA (US)

(72) Inventors: Kedar PHATAK, Vienna, VA (US); Ajit DHOBALE, Fremont, CA (US); Allison Fenichel MCMILLAN, Brooklyn, NY (US); Aditya PAI, Brooklyn, NY (US)

(73) Assignee: Capital One Services, LLC, McLean, VA (US)

(21) Appl. No.: 18/441,929

(22) Filed: Feb. 14, 2024

(51) Int. Cl. G06N 3/08; G06N 5/022

(52) U.S. Cl. CPC G06N 3/08; G06N 5/022

(57) ABSTRACT

Systems and methods for training machine learning models using differentiation. In some aspects, the system receives a set of triplet inputs. Each triplet input includes a resource access request, a correct reference classification, and an incorrect classification. The system initializes a first machine learning model. The system updates the first machine learning model by, for each triplet input in the set of triplet inputs, processing the resource access request using the first machine learning model first in conjunction with the correct reference classification then in conjunction with the incorrect classification to generate a set of first distances and a set of second distances, respectively. Based on the set of first distances and the set of second distances, the system computes a loss metric to update parameters for the first machine learning model. The system processes second resource access requests using the first machine learning model to generate predicted classifications.

### SUMMARY

Methods and systems are described herein for novel uses and/or improvements to artificial intelligence applications. As one example, methods and systems are described herein for training a Siamese neural network to identify correct classifications for resource access requests.

Conventional systems for classification often use plain training data which typically fails to capture nuanced differences between correct and incorrect classifications. This leads to some cases being challenging for machine learning models to accurately label with classifications, especially when a scarcity of similar cases compounds the difficulty of classifying particular edge cases. Conventional systems have not contemplated using triplet input training data to train a Siamese network for fine-tuned and hard-to-identify distinctions between classifications for superior accuracy in labeling, for example, resource access requests. Conventional systems have additionally not contemplated using the erroneous classifications of past machine learning models to identify areas of particular challenge, and incorporating information gained from the training of a preliminary model into the training data and training methods for the Siamese neural network.

Methods and systems disclosed herein achieve higher performance in distinguishing classifications and accuracy in identifying correct classifications for resource access requests by using triplet inputs for training data. Each triplet input includes a resource access request, a correct reference classification of the resource access request, and an incorrect predicted classification of the resource access request output by a preliminary machine learning model. After initialization, the Siamese neural network is trained by an iterative repetition of generating a first distance and a second distance for each triplet input. The first distance is generated by processing the resource access request in conjunction with the correct reference classification, the second distance by processing the resource access request in conjunction with the incorrect predicted classification. Using the first distances and second distances, each corresponding to a triplet input, the system computes a loss metric and uses the metric to update parameters of the neural network. When the system halts the iterative repetition due to the loss metric performing sufficiently well, the result is a machine learning model able to more accurately differentiate between classifications, with better expected performance especially on areas where conventional systems struggle.

In some aspects, methods and systems are described herein comprising: receiving a set of triplet inputs, wherein each triplet input in the set of triplet inputs comprises a resource access request, a correct reference classification, and an incorrect classification; initializing a first machine learning model, the first machine learning model comprising a first set of parameters; iteratively performing the following steps: generating a set of first distances by, for each triplet input in the set of triplet inputs, processing the resource access request in conjunction with the correct reference classification in the triplet input using the first machine learning model to obtain a first distance; generating a set of second distances by, for each triplet input in the set of triplet inputs, processing the resource access request in conjunction with the incorrect classification in the triplet input using the first machine learning model to obtain a second distance; based on the set of first distances and the set of second distances, computing a loss metric for the first machine learning model; based on the loss metric, updating the first set of parameters for the first machine learning model; and processing second resource access requests, using the first machine learning model, to generate a second set of predicted classifications for the second resource access requests.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for training machine learning models using differentiation, in accordance with one or more embodiments.

FIG. 2 show an illustration of a machine learning model before and after being trained using differentiation to perform classification, in accordance with one or more embodiments.

FIG. 3 shows illustrative components for a system for training machine learning models using differentiation, in accordance with one or more embodiments.

FIG. 4 shows a flowchart of the steps involved in training machine learning models using differentiation, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

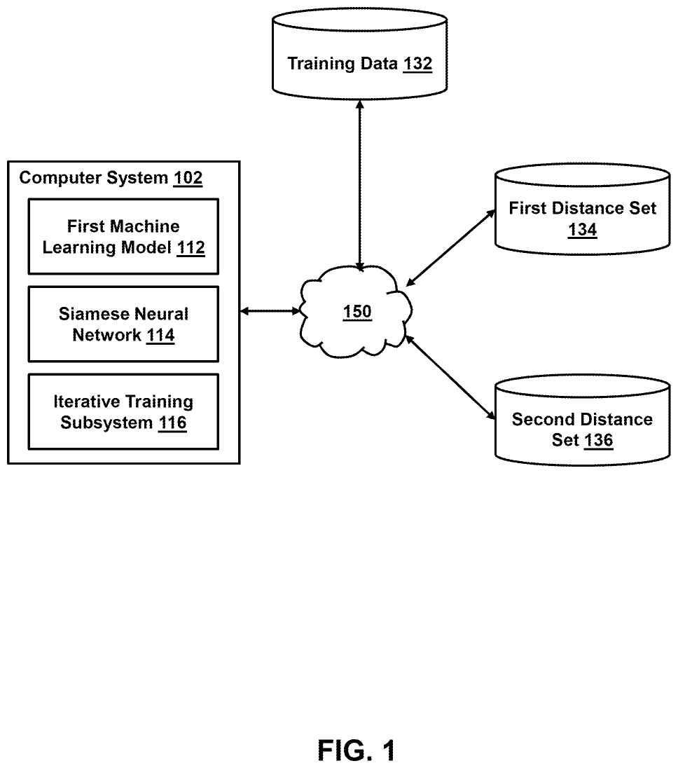

FIG. 1 shows an illustrative diagram for system 150, which contains hardware and software components used to train resource consumption machine learning models, extract explainability vectors and perform feature engineering, in accordance with one or more embodiments. For example, Computer System 102, a part of system 150, may include First Machine Learning Model 112, Siamese Neural Network 114, and Iterative Training Subsystem 116. Additionally, system 150 may create, store, and retrieve Training Data 132, First Distance Set 134, and/or Second Distance Set 136.

System 150 (the system) may receive Training Data 132. Training Data 132 may include a plurality of triplet inputs, each of which includes a resource access request, an incorrect classification, and a correct classification. The correct classification corresponds to an acceptable classification for the resource access request among one or more acceptable classifications. The incorrect classification may be chosen to resemble the correct classification, yet be an unacceptable classification for the resource access request. For example, each triplet input in Training Data 132 may be generated using a prototype machine learning model (e.g., First Machine Learning Model 112). First Machine Learning Model 112 may be trained to predict classifications for input resource access requests represented as a first set of features. First Machine Learning Model 112 produces an output classification for each input resource access request, and the output classifications may be compared against a testing dataset to determine whether each output classification is correct. First Machine Learning Model 112 may produce some output classifications that differ from the correct classification in the testing dataset, and the system may collect such instances to store in Training Data 132, where the input resource access request is stored in association with the correct classification in the training dataset as well as the incorrect classification output by First Machine Learning Model 112.

In such embodiments, First Machine Learning Model 112 may be trained on a training dataset including sample resource access requests and a set of sample classifications. First Machine Learning Model 112 may use algorithms such as logistic regression, naïve bayes, and support vector machine. First Machine Learning model may be trained on a dataset other than Training Data 132, and the system may use supervised or unsupervised learning to tune the parameters of First Machine Learning Model 112 such that it produces classifications for resource access requests. The system may consider classifications generated by First Machine Learning Model 112 unreliable, for example due to a paucity of training data, or due to a simplistic model architecture. Thus, the system may generate Training Data 132 using the incorrect classifications output by First Machine Learning Model 112 for the purpose of training a sophisticated machine learning model (e.g., Siamese Neural Network 114).

In some other embodiments, Training Data 132 may be generated based on distances between classifications. Each triplet input in Training Data 132 may be generated by taking a pair of a resource access request and a correct classification and identifying a closest incorrect classification. The incorrect classification may be identified using an embedding map which represents all classifications as vectors of real numbers in a real-numbered space. The embedding map takes as input a first set of features representing a classification, where the first set of features may include text descriptions and real numbers. The embedding map uses a predetermined set of rules to transform the first set of features into a real-valued vector. The system may calculate a distance to the correct classification for all other classifications based on their embeddings to real-valued vectors, and choose the closest classification to the correct classification as the incorrect classification used in the triplet input. The embedding map may be retrieved from a database, and may have been trained using a clustering algorithm. In some embodiments, the embedding map may be part of First Machine Learning Model 112.

In some other embodiments, Training Data 132 may include triplet inputs that include a classification, a member resource access request, and a nonmember resource access request. The classification is applicable to the member resource access request but no to the nonmember resource access request. The system may generate Training Data 132 using the incorrect classifications output by First Machine Learning Model 112. For example, First Machine Learning Model 112 may classify some input resource access requests incorrectly. First Machine Learning Model 112 may, for example, classify a first resource access request as scam when the appropriate classification is phishing, as indicated by a testing dataset. First Machine Learning Model 112 may classify a second resource access request correctly as scam. The system may generate a triplet input in Training Data 132 using the first resource access request, the second resource access request, and the classification, which is scam. In such embodiments as described above, the system may use Training Data 132 to train Siamese Neural Network 114 to generate a confidence score that a classification is appropriate for a resource access request.

Training Data 132 may contain a set of features describing each triplet input in Training Data 132, which may be used as input by a machine learning model (e.g., Siamese Neural Network 114). Training Data 132 may, for example, include a plurality of resource access requests and corresponding correct and incorrect classifications. A resource access request may, for example, represent changes to an account. A resource access request may be described by parameters and features, the values for which are real numbers, the features and parameters including: an extent of resource access, a category of resource access, a duration and a frequency of the resource access, and an account to which the resource request is directed. Each triplet input described by the set of features may include a resource access request, a correct classification, and an incorrect classification. The process of determining an incorrect classification to be used in Training Data 132 based on the correct classification and/or the resource access request is described above. The system may partition a triplet input in Training Data 132 for use in training or testing a machine learning model (e.g., Siamese Neural Network 114). For example, the system may cause Siamese Neural Network 114 to process as input the resource access request and the correct reference classification from a triplet input in order to generate a first distance. The system may then cause Siamese Neural Network 114 to process as input the same resource access request with the incorrect classification, from the same triplet input, to generate a second distance. The system may, for example, contrast the first distance with the second to evaluate the performance of Siamese Neural Network 114.

In some embodiments, the system may process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

The system may partition Training Data 132 into a training set and a cross-validating set. Using the training set, the system may train Siamese Neural Network 114 using, for example, the gradient descent technique. The system may then cross-validate the trained model using the cross-validating set and further fine-tune the parameters of the model. Siamese Neural Network 114 may include one or more parameters that it uses to translate input into outputs. For example, an artificial neural network contains a matrix of weights, each weight in which is a real number. The repeated multiplication and combination of weights transform input values to Siamese Neural Network 114 into output values. The system may measure the performance of Siamese Neural Network 114 using a method such as cross-validation to generate a quantitative representation, e.g., an error rate.

The system may prepare to train a machine learning model (e.g., Siamese Neural Network 114) based on Training Data 132. Siamese Neural Network 114 may take as input a vector of feature values for features representing a resource access request and output a classification for the resource access request. The first set of features may include quantitative and categorical features describing aspects of the resource access request. The first set of features may correspond to the part of the set of features in Training Data 132. Siamese Neural Network 114 may use one or more algorithms like artificial neural networks, deep neural networks, generative adversarial networks and other neural-network algorithms. The system may, in preparation of training Siamese Neural Network 114, determine a model architecture and a hyperparameter configuration for Siamese Neural Network 114. For example, the system may choose a number of layers and the number of neurons in each layer for the neural network. The system may also choose activation functions, backpropagation rates and other hyperparameters for the neural network. In some embodiments, the system may choose the model architecture and the hyperparameter configuration based on Training Data 132. In other embodiments, the system may use a standard model architecture and hyperparameter configuration common in processing resource access requests of the sort included in Training Data 132. The system may also initialize values for one or more parameters to preset values. For example, the system may initialize all the weights and biases within the neural network of Siamese Neural Network 114 to be a predetermined real value. The parameter values may correspond to weights and biases defining one or more neurons in the neural network, and may be updated during the training of Siamese Neural Network 114.

The system may train Siamese Neural Network 114 using Training Data 132 by iteratively reinforcing Siamese Neural Network 114 using a gradient descent technique, for example. The system may generate a set of first feature vectors, each feature vector in which includes the resource access request and the correct reference classification for a triplet input in Training Data 132. The system may generate a set of second feature vectors, each feature vector in which includes the resource access request and the incorrect classification for a triplet input in Training Data 132. The set of first feature vectors corresponds with the set of second feature vectors, since a triplet input will correspond to a first feature vector and a second feature vector. The system may cause Siamese Neural Network 114 to process a first feature vector to generate a first distance. Using the same parameters and the same hyperparameter configuration, the system may cause Siamese Neural Network 114 to process a second feature vector corresponding to the same triplet input as the first and generate a second distance. The first and second distances were generated using the very same neural network setup, and therefore any distinction between the first distance and the second is due to how the first feature vector and the second feature vector were handled by the neural network.

In the embodiments where each triplet input within the Training Data 132 includes a classification, a member resource access request, and a nonmember resource access request, the system may generate a first feature vector including the classification and the member resource access request of the triplet input. The second feature vector includes the classification and the nonmember resource access request of the triplet input. The system may cause Siamese Neural Network 114 to process the first feature vector to generate a first distance, in the same process as the embodiment above. The system may cause Siamese Neural Network 114 to process the second feature vector with identical parameters to generate a second distance, also in the same process as the embodiment above. The system may also use the first distance and the second distance to generate a loss metric and update the parameters of Siamese Neural Network 114 in the same process as described below.

Based on the first distance and the second distance, the system may compute a loss metric for Siamese Neural Network 114. For example, a loss metric may be computed to be a mathematical combination of the first distance and the second distance. A mathematical combination could be the second distance divided by the first distance. Alternatively, the mathematical combination could be a sigmoid function taking the first distance and the second distance as inputs. The mathematical combination may produce a penalty value for Siamese Neural Network 114 based on the first distance and second distance. The penalty value may be the loss metric used in a gradient descent technique or stochastic gradient descent technique to update the parameters of Siamese Neural Network 114. The penalty value may be representative of the desirability of the first distance, the second distance, or the relationship between the first distance and the second distance. For example, the system may incentivize Siamese Neural Network 114 to produce small values for the first distance and large values for the second distance, since resource access requests ought to be labeled close to the correct classification and far from the incorrect classification by Siamese Neural Network 114. In addition, the first distance should be significantly smaller than the second distance, since the system may incentivize Siamese Neural Network 114 to delineate between the correct classification and an incorrect classification that looks similar. Therefore, the penalty value is used as a loss metric by a loss function, for example in a reinforcement learning algorithm. The reinforcement learning algorithm may, for example, use the penalty value to generate a set of parameter updates. The set of parameter updates indicate which parameters of Siamese Neural Network 114 are to be changed and to what extent. Alternatively, the system may use a backpropagation technique to determine the set of parameter updates based on the loss metric. The system may compute a loss metric for each triplet input in Training Data 132 by generating a first feature vector and a second feature vector from the triplet input, and using the distances corresponding to the feature vectors to generate a loss metric. The system may use a stochastic gradient descent technique to update the parameters of Siamese Neural Network 114 based on each loss metric. With the updated parameters for Siamese Neural Network 114, the system may process the next pair of feature vectors from a different triplet input. The system may iterate this process for each triplet input in Training Data 132. In some embodiments, the system may batch the updates to parameters of Siamese Neural Network 114. For example, the system may cause Siamese Neural Network 114 to process a set number of feature inputs in the form of first and second feature vectors, generate a set of loss metrics, and use the set of loss metrics to determine updates to parameters of Siamese Neural Network 114. For example, the system may take an average of the loss metrics, and use gradient descent and backpropagation to determine changes to parameter values of Siamese Neural Network 114.

The system may determine to stop the iterative repetition of processing a first feature vector and a second feature vector, generating a loss metric based on the first distance and second distance, and updating the parameters of Siamese Neural Network 114 based on the performance of Siamese Neural Network 114. For example, the system may stop the iterative repetition in response to detecting that the loss metric of Siamese Neural Network 114 has reached a threshold value. Alternatively, the system may stop the iterative repetition when the error rate of Siamese Neural Network 114 falls below a threshold. For example, the system may compute an error rate for Siamese Neural Network 114 based on a testing or cross-validating dataset in Training Data 132. For each set of updated parameters for Siamese Neural Network 114, the system may compute an error rate. If the error rate corresponding to a set of parameters falls below a threshold value, the system may adopt the set of parameters as final for Siamese Neural Network 114.

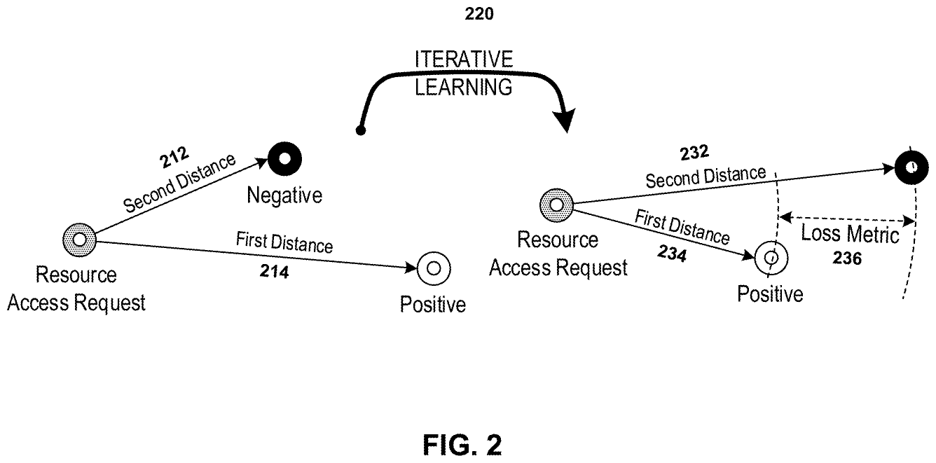

FIG. 2 shows the results of the iterative training process that generates and updates the parameters for Siamese Neural Network 114. Before the iterative training process, Siamese Neural Network 114 may determine a Second Distance 212 and a First Distance 214. Second Distance 212 is a distance from the resource access request to the incorrect classification, whereas First Distance 214 is a distance from the resource access request to the correct classification. For example, Siamese Neural Network 114, prior to training, may embed a resource access request into a vector of real values using its weights and biases. The vector of real values representing the resource access request may be represented as a point in multi-dimensional space. Similarly, the correct classification may be represented by a second vector of real values, and the incorrect classification may be represented by a third vector. Graphically, the resource access request, the correct classification, and the incorrect classification form three points respectively described by vector of real values. The distance from the resource access request to a point representing a classification represent the similarity of that classification to the resource access request. As shown on FIG. 2, Second Distance 212 is greater in length than First Distance 214. This would be a case of incorrect classification. Though the correct classification resembles the incorrect classification in this case, the intention for training Siamese Neural Network 114 is for Siamese Neural Network 114 to be able to correctly assign the correct classification a shorter distance than the incorrect classification from the resource access request.

The system may apply Iterative Training 220 to update parameter values, such as weights as biases, of Siamese Neural Network 114. The system may train Siamese Neural Network 114 using Training Data 132 by iteratively reinforcing Siamese Neural Network 114 using a gradient descent technique, for example. The system may generate a set of first feature vectors, each feature vector in which includes the resource access request and the correct reference classification for a triplet input in Training Data 132. The system may generate a set of second feature vectors, each feature vector in which includes the resource access request and the incorrect classification for a triplet input in Training Data 132. The set of first feature vectors corresponds with the set of second feature vectors, since a triplet input will correspond to a first feature vector and a second feature vector. The system may cause Siamese Neural Network 114 to process a first feature vector to generate a first distance. Using the same parameters and the same hyperparameter configuration, the system may cause Siamese Neural Network 114 to process a second feature vector corresponding to the same triplet input as the first and generate a second distance. The first and second distances were generated using the very same neural network setup, and therefore any distinction between the first distance and the second is due to how the first feature vector and the second feature vector were handled by the neural network.

Based on the first distance and the second distance, the system may compute a loss metric for Siamese Neural Network 114, much like Loss Metric 236. For example, a loss metric may be computed to be a mathematical combination of the first distance and the second distance. A mathematical combination could be the second distance divided by the first distance. Alternatively, the mathematical combination could be a sigmoid function taking the first distance and the second distance as inputs. The mathematical combination may produce a penalty value for Siamese Neural Network 114 based on the first distance and second distance. The penalty value may be the loss metric used in a gradient descent technique or stochastic gradient descent technique to update the parameters of Siamese Neural Network 114. The penalty value may be representative of the desirability of the first distance, the second distance, or the relationship between the first distance and the second distance. For example, the system may incentivize Siamese Neural Network 114 to produce small values for the first distance and large values for the second distance, since resource access requests ought to be labeled close to the correct classification and far from the incorrect classification by Siamese Neural Network 114. In addition, the first distance should be significantly smaller than the second distance, since the system may incentivize Siamese Neural Network 114 to delineate between the correct classification and an incorrect classification that looks similar. Therefore, the penalty value is used as a loss metric by a loss function, for example in a reinforcement learning algorithm. The reinforcement learning algorithm may, for example, use the penalty value to generate a set of parameter updates. The set of parameter updates indicate which parameters of Siamese Neural Network 114 are to be changed and to what extent. Alternatively, the system may use a backpropagation technique to determine the set of parameter updates based on the loss metric. The system may compute a loss metric for each triplet input in Training Data 132 by generating a first feature vector and a second feature vector from the triplet input, and using the distances corresponding to the feature vectors to generate a loss metric. The system may use a stochastic gradient descent technique to update the parameters of Siamese Neural Network 114 based on each loss metric. With the updated parameters for Siamese Neural Network 114, the system may process the next pair of feature vectors from a different triplet input. The system may iterate this process for each triplet input in Training Data 132. In some embodiments, the system may batch the updates to parameters of Siamese Neural Network 114. For example, the system may cause Siamese Neural Network 114 to process a set number of feature inputs in the form of first and second feature vectors, generate a set of loss metrics, and use the set of loss metrics to determine updates to parameters of Siamese Neural Network 114. For example, the system may take an average of the loss metrics, and use gradient descent and backpropagation to determine changes to parameter values of Siamese Neural Network 114.

The result of Iterative Training 220 is shown in Second Distance 232, First Distance 234 and Loss Metric 236. Iterative Training 220 has updated the parameters of Siamese Neural Network 114 such that it now outputs vectors representing classifications, resulting in Second Distance 232 from the resource access request to the incorrect classification and First Distance 234 from the resource access request to the correct classification. Unlike with Second Distance 212 and First Distance 214, Siamese Neural Network 114 has correctly judged the incorrect classification to be further from the resource access request than the correct classification. Second Distance 232 is greater than First Distance 234, resulting in the correct classification of the resource access request. The system may capture the improvement of Siamese Neural Network 114's performance by Loss Metric 236. Loss Metric 236 may in some embodiments be the difference between Second Distance 232 and First Distance 234. In other embodiments, Loss Metric 236 may be a binary value indicating whether the incorrect classification is further from the resource access request than the correct classification. As Siamese Neural Network 114 improves its ability to differentiate between incorrect and correct classifications, improvements in Loss Metric 236 capture the extent of its improvement. When Loss Metric 236 reaches a certain threshold, the system may halt Iterative Training 220 because Siamese Neural Network 114 performs well enough at assigning resource access requests their correct classifications.

For example, the system may use Siamese Neural Network 114 to generate classifications for a transaction for a user account. The system may need to determine a merchant, a category of transaction, and/or a location of the merchant corresponding to the transaction. For example, for a transaction of a known amount associated with a user account, the system may need to determine the store at which the transaction took place. In addition, the system may need to identify the nature of the transaction, in order to correctly enter the transaction into account state records. Therefore, the system may assign a resource access request (e.g., a transaction for a user account) to one or more classifications using Siamese Neural Network 114. Siamese Neural Network 114 may process an input vector containing data and metadata relating to the transaction, and use its neural network to generate an output indicating a classification for the transaction. The classification may, for example, indicate the branch of a fast food chain at which the transaction took place. In another example, the classification may indicate a category of purchase for the transaction. In some embodiments, the triplet input data used to train Siamese Neural Network 114 may contain a transaction, an incorrect classification corresponding to an incorrect merchant, and a correct classification corresponding to the correct merchant. In some other embodiments, the triplet input data may contain a merchant, an incorrect classification corresponding to a transaction not with the merchant, and a correct classification corresponding to a transaction that was with the merchant. In such embodiments, Siamese Neural Network 114 was trained to assign to input merchants classifications which indicate transactions that should be assigned to the merchant.

In an alternate embodiment, the system may use Siamese Neural Network 114 to generate reasons for determinations relating to credit applications. In processing applications for a credit card, a loan or another financial instrument, a justification is often necessary for approval or rejection decisions. Thus, the system may wish to assign a resource access request to a classification, the classification being a category of reasons for approval or rejection for reporting and compliance purposes. Thus, the system may train Siamese Neural Network 114 to accurately ascribe to a credit application its reasons for approval or rejection. For example, Siamese Neural Network 114 may classify credit applications as being rejected for short length of credit, excessive utilization, or late payment. The system may train Siamese Neural Network 114 on triplet input data, for example including a credit application and its features represented as a vector, a correct classification for rejection reasons (e.g., a history of late payment), and an incorrect classification for rejection reasons (e.g., insufficient collateral). The triplet input data may be designed to juxtapose correct and incorrect classifications for the same resource access request such that Siamese Neural Network 114 is able to more finely distinguish between the classifications and achieve a greater degree of nuance in considering reasons for rejecting credit applications.

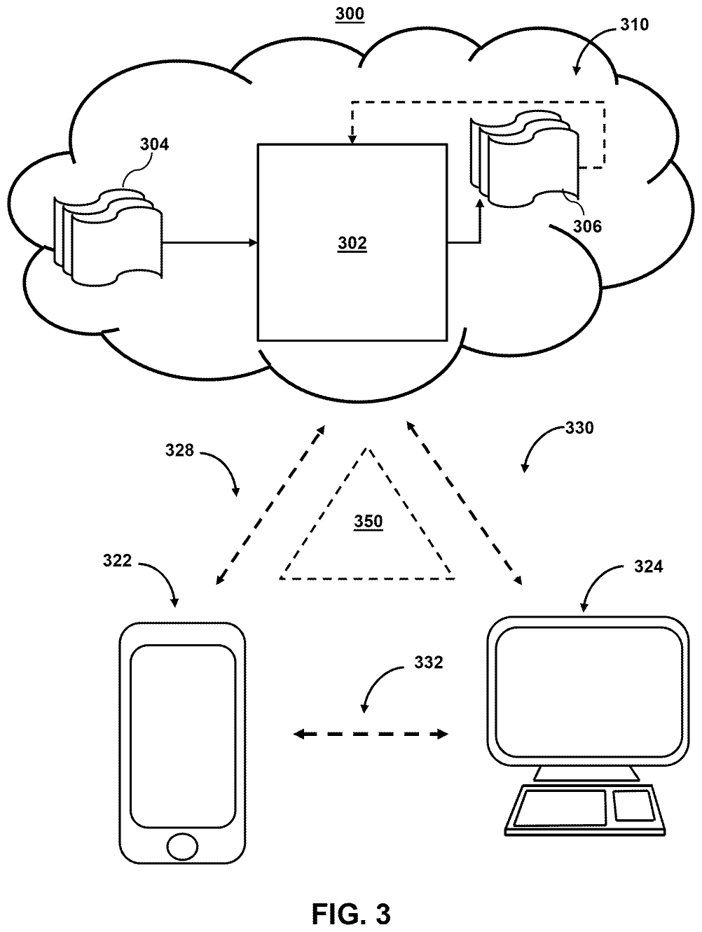

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the Machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

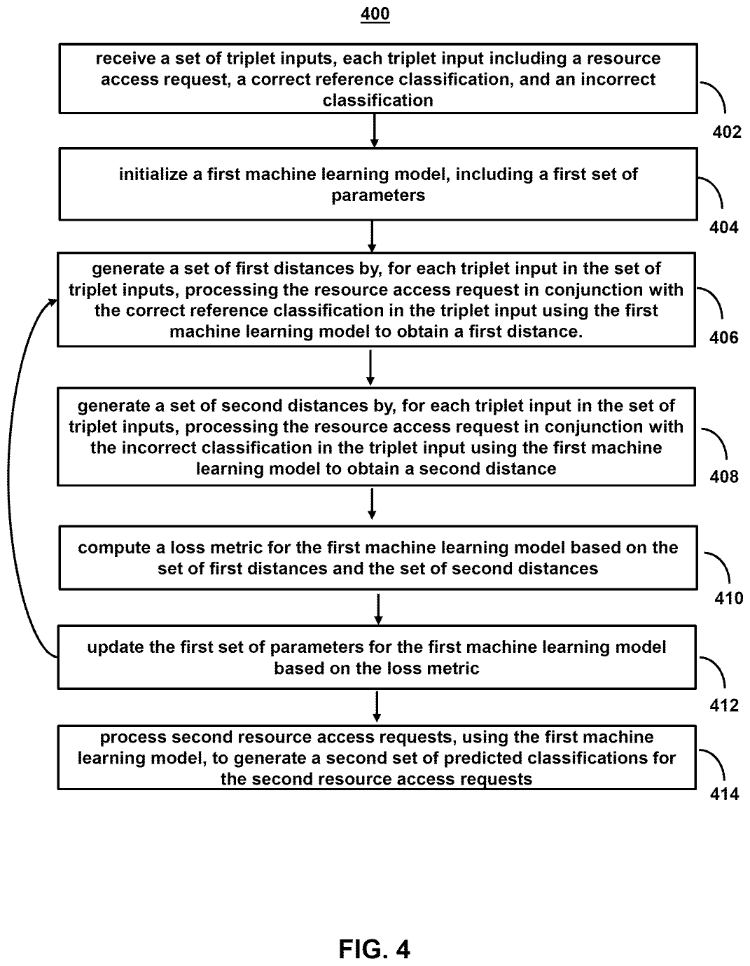

FIG. 4 shows a flowchart of the steps involved in generate recommendations for reducing resource consumption, in accordance with one or more embodiments. For example, the system may use process 400 (e.g., as implemented on one or more system components described above) in order to collect and process data about users, train Machine Learning Models, extract explainability vectors, and select and recombine features.

At step 402, process 400 (e.g., using one or more components described above) may receive a set of triplet inputs, each triplet input including a resource access request, a correct reference classification, and an incorrect classification.

System 150 (the system) may receive Training Data 132. Training Data 132 may include a plurality of triplet inputs, each of which includes a resource access request, an incorrect classification, and a correct classification. The correct classification corresponds to an acceptable classification for the resource access request among one or more acceptable classifications. The incorrect classification may be chosen to resemble the correct classification, yet be an unacceptable classification for the resource access request. For example, each triplet input in Training Data 132 may be generated using a prototype machine learning model (e.g., First Machine Learning Model 112). First Machine Learning Model 112 may be trained to predict classifications for input resource access requests represented as a first set of features. First Machine Learning Model 112 produces an output classification for each input resource access request, and the output classifications may be compared against a testing dataset to determine whether each output classification is correct. First Machine Learning Model 112 may produce some output classifications that differ from the correct classification in the testing dataset, and the system may collect such instances to store in Training Data 132, where the input resource access request is stored in association with the correct classification in the training dataset as well as the incorrect classification output by First Machine Learning Model 112.

In such embodiments, First Machine Learning Model 112 may be trained on a training dataset including sample resource access requests and a set of sample classifications. First Machine Learning Model 112 may use algorithms such as logistic regression, naïve bayes, and support vector machine. First Machine Learning model may be trained on a dataset other than Training Data 132, and the system may use supervised or unsupervised learning to tune the parameters of First Machine Learning Model 112 such that it produces classifications for resource access requests. The system may consider classifications generated by First Machine Learning Model 112 unreliable, for example due to a paucity of training data, or due to a simplistic model architecture. Thus, the system may generate Training Data 132 using the incorrect classifications output by First Machine Learning Model 112 for the purpose of training a sophisticated machine learning model (e.g., Siamese Neural Network 114).

In some other embodiments, Training Data 132 may be generated based on distances between classifications. Each triplet input in Training Data 132 may be generated by taking a pair of a resource access request and a correct classification and identifying a closest incorrect classification. The incorrect classification may be identified using an embedding map which represents all classifications as vectors of real numbers in a real-numbered space. The embedding map takes as input a first set of features representing a classification, where the first set of features may include text descriptions and real numbers. The embedding map uses a predetermined set of rules to transform the first set of features into a real-valued vector. The system may calculate a distance to the correct classification for all other classifications based on their embeddings to real-valued vectors, and choose the closest classification to the correct classification as the incorrect classification used in the triplet input. The embedding map may be retrieved from a database, and may have been trained using a clustering algorithm. In some embodiments, the embedding map may be part of First Machine Learning Model 112.

In some other embodiments, Training Data 132 may include triplet inputs that include a classification, a member resource access request, and a nonmember resource access request. The classification is applicable to the member resource access request but no to the nonmember resource access request. The system may generate Training Data 132 using the incorrect classifications output by First Machine Learning Model 112. For example, First Machine Learning Model 112 may classify some input resource access requests incorrectly. First Machine Learning Model 112 may, for example, classify a first resource access request as scam when the appropriate classification is phishing, as indicated by a testing dataset. First Machine Learning Model 112 may classify a second resource access request correctly as scam. The system may generate a triplet input in Training Data 132 using the first resource access request, the second resource access request, and the classification, which is scam. In such embodiments as described above, the system may use Training Data 132 to train Siamese Neural Network 114 to generate a confidence score that a classification is appropriate for a resource access request.

At step 404, process 400 (e.g., using one or more components described above) may initialize a first machine learning model (e.g., Siamese Neural Network 114), including a first set of parameters

Training Data 132 may contain a set of features describing each triplet input in Training Data 132, which may be used as input by a machine learning model (e.g., Siamese Neural Network 114). Training Data 132 may, for example, include a plurality of resource access requests and corresponding correct and incorrect classifications. A resource access request may, for example, represent changes to an account. A resource access request may be described by parameters and features, the values for which are real numbers, the features and parameters including: an extent of resource access, a category of resource access, a duration and a frequency of the resource access, and an account to which the resource request is directed. Each triplet input described by the set of features may include a resource access request, a correct classification, and an incorrect classification. The process of determining an incorrect classification to be used in Training Data 132 based on the correct classification and/or the resource access request is described above. The system may partition a triplet input in Training Data 132 for use in training or testing a machine learning model (e.g., Siamese Neural Network 114). For example, the system may cause Siamese Neural Network 114 to process as input the resource access request and the correct reference classification from a triplet input in order to generate a first distance. The system may then cause Siamese Neural Network 114 to process as input the same resource access request with the incorrect classification, from the same triplet input, to generate a second distance. The system may, for example, contrast the first distance with the second to evaluate the performance of Siamese Neural Network 114.

In some embodiments, the system may process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

The system may partition Training Data 132 into a training set and a cross-validating set. Using the training set, the system may train Siamese Neural Network 114 using, for example, the gradient descent technique. The system may then cross-validate the trained model using the cross-validating set and further fine-tune the parameters of the model. Siamese Neural Network 114 may include one or more parameters that it uses to translate input into outputs. For example, an artificial neural network contains a matrix of weights, each weight in which is a real number. The repeated multiplication and combination of weights transform input values to Siamese Neural Network 114 into output values. The system may measure the performance of Siamese Neural Network 114 using a method such as cross-validation to generate a quantitative representation, e.g., an error rate.

The system may prepare to train a machine learning model (e.g., Siamese Neural Network 114) based on Training Data 132. Siamese Neural Network 114 may take as input a vector of feature values for features representing a resource access request and output a classification for the resource access request. The first set of features may include quantitative and categorical features describing aspects of the resource access request. The first set of features may correspond to the part of the set of features in Training Data 132. Siamese Neural Network 114 may use one or more algorithms like artificial neural networks, deep neural networks, generative adversarial networks and other neural-network algorithms. The system may, in preparation of training Siamese Neural Network 114, determine a model architecture and a hyperparameter configuration for Siamese Neural Network 114. For example, the system may choose a number of layers and the number of neurons in each layer for the neural network. The system may also choose activation functions, backpropagation rates and other hyperparameters for the neural network. In some embodiments, the system may choose the model architecture and the hyperparameter configuration based on Training Data 132. In other embodiments, the system may use a standard model architecture and hyperparameter configuration common in processing resource access requests of the sort included in Training Data 132. The system may also initialize values for one or more parameters to preset values. For example, the system may initialize all the weights and biases within the neural network of Siamese Neural Network 114 to be a predetermined real value. The parameter values may correspond to weights and biases defining one or more neurons in the neural network, and may be updated during the training of Siamese Neural Network 114.

The system may iteratively perform steps 406, 408, 410 and 412 in that order to train Siamese Neural Network 114.

At step 406, process 400 (e.g., using one or more components described above) may generate a set of first distances by, for each triplet input in the set of triplet inputs, processing the resource access request in conjunction with the correct reference classification in the triplet input using the first machine learning model to obtain a first distance. The system may train Siamese Neural Network 114 using Training Data 132 by iteratively reinforcing Siamese Neural Network 114 using a gradient descent technique, for example. The system may generate a set of first feature vectors, each feature vector in which includes the resource access request and the correct reference classification for a triplet input in Training Data 132. The system may generate a set of second feature vectors, each feature vector in which includes the resource access request and the incorrect classification for a triplet input in Training Data 132. The set of first feature vectors corresponds with the set of second feature vectors, since a triplet input will correspond to a first feature vector and a second feature vector. The system may cause Siamese Neural Network 114 to process a first feature vector to generate a first distance. For example, the system may use the neural-network weights and biases of Siamese Neural Network 114 to translate the first feature vector into a numeric value corresponding to the first distance.

At step 408, process 400 (e.g., using one or more components described above) may generate a set of second distances by, for each triplet input in the set of triplet inputs, processing the resource access request in conjunction with the incorrect classification in the triplet input using the first machine learning model to obtain a second distance. Concurrently to generating a first distance using a first feature vector, the system may use the same parameters and the same hyperparameter configuration of Siamese Neural Network 114 to process a second feature vector corresponding to the same triplet input as the first and generate a second distance. The first and second distances were generated using the very same neural network setup, and therefore any distinction between the first distance and the second is due to how the first feature vector and the second feature vector were handled by the neural network.

In the embodiments where each triplet input within the Training Data 132 includes a classification, a member resource access request, and a nonmember resource access request, the system may generate a first feature vector including the classification and the member resource access request of the triplet input. The second feature vector includes the classification and the nonmember resource access request of the triplet input. The system may cause Siamese Neural Network 114 to process the first feature vector to generate a first distance, in the same process as the embodiment above. The system may cause Siamese Neural Network 114 to process the second feature vector with identical parameters to generate a second distance, also in the same process as the embodiment above. The system may also use the first distance and the second distance to generate a loss metric and update the parameters of Siamese Neural Network 114 in the same process as described below.

At step 410, process 400 (e.g., using one or more components described above) may compute a loss metric for the first machine learning model based on the set of first distances and the set of second distances. Based on the first distance and the second distance, the system may compute a loss metric for Siamese Neural Network 114. For example, a loss metric may be computed to be a mathematical combination of the first distance and the second distance. A mathematical combination could be the second distance divided by the first distance. Alternatively, the mathematical combination could be a sigmoid function taking the first distance and the second distance as inputs. The mathematical combination may produce a penalty value for Siamese Neural Network 114 based on the first distance and second distance. The penalty value may be the loss metric used in a gradient descent technique or stochastic gradient descent technique to update the parameters of Siamese Neural Network 114. The penalty value may be representative of the desirability of the first distance, the second distance, or the relationship between the first distance and the second distance. For example, the system may incentivize Siamese Neural Network 114 to produce small values for the first distance and large values for the second distance, since resource access requests ought to be labeled close to the correct classification and far from the incorrect classification by Siamese Neural Network 114. In addition, the first distance should be significantly smaller than the second distance, since the system may incentivize Siamese Neural Network 114 to delineate between the correct classification and an incorrect classification that looks similar. Therefore, the penalty value is used as a loss metric by a loss function, for example in a reinforcement learning algorithm.

At step 412, process 400 (e.g., using one or more components described above) may update the first set of parameters for the first machine learning model based on the loss metric. A reinforcement learning algorithm may, for example, use the penalty value to generate a set of parameter updates. The set of parameter updates indicate which parameters of Siamese Neural Network 114 are to be changed and to what extent. Alternatively, the system may use a backpropagation technique to determine the set of parameter updates based on the loss metric. The system may compute a loss metric for each triplet input in Training Data 132 by generating a first feature vector and a second feature vector from the triplet input, and using the distances corresponding to the feature vectors to generate a loss metric. The system may use a stochastic gradient descent technique to update the parameters of Siamese Neural Network 114 based on each loss metric. With the updated parameters for Siamese Neural Network 114, the system may process the next pair of feature vectors from a different triplet input. The system may iterate this process for each triplet input in Training Data 132. In some embodiments, the system may batch the updates to parameters of Siamese Neural Network 114. For example, the system may cause Siamese Neural Network 114 to process a set number of feature inputs in the form of first and second feature vectors, generate a set of loss metrics, and use the set of loss metrics to determine updates to parameters of Siamese Neural Network 114. For example, the system may take an average of the loss metrics, and use gradient descent and backpropagation to determine changes to parameter values of Siamese Neural Network 114.

The system may determine to stop the iterative repetition of processing a first feature vector and a second feature vector, generating a loss metric based on the first distance and second distance, and updating the parameters of Siamese Neural Network 114 based on the performance of Siamese Neural Network 114. For example, the system may stop the iterative repetition in response to detecting that the loss metric of Siamese Neural Network 114 has reached a threshold value. Alternatively, the system may stop the iterative repetition when the error rate of Siamese Neural Network 114 falls below a threshold. For example, the system may compute an error rate for Siamese Neural Network 114 based on a testing or cross-validating dataset in Training Data 132. For each set of updated parameters for Siamese Neural Network 114, the system may compute an error rate. If the error rate corresponding to a set of parameters falls below a threshold value, the system may adopt the set of parameters as final for Siamese Neural Network 114.

At step 414, process 400 (e.g., using one or more components described above) may process second resource access requests, using the first machine learning model, to generate a second set of predicted classifications for the second resource access requests. For example, the system may process resource access requests not in the training data of Siamese Neural Network 114. For example, the system may use Siamese Neural Network 114 to generate classifications for a transaction for a user account. The system may need to determine a merchant, a category of transaction, and/or a location of the merchant corresponding to the transaction. For example, for a transaction of a known amount associated with a user account, the system may need to determine the store at which the transaction took place. In addition, the system may need to identify the nature of the transaction, in order to correctly enter the transaction into account state records. Therefore, the system may assign a resource access request (e.g., a transaction for a user account) to one or more classifications using Siamese Neural Network 114. Siamese Neural Network 114 may process an input vector containing data and metadata relating to the transaction, and use its neural network to generate an output indicating a classification for the transaction. The classification may, for example, indicate the branch of a fast food chain at which the transaction took place. In another example, the classification may indicate a category of purchase for the transaction. In some embodiments, the triplet input data used to train Siamese Neural Network 114 may contain a transaction, an incorrect classification corresponding to an incorrect merchant, and a correct classification corresponding to the correct merchant. In some other embodiments, the triplet input data may contain a merchant, an incorrect classification corresponding to a transaction not with the merchant, and a correct classification corresponding to a transaction that was with the merchant. In such embodiments, Siamese Neural Network 114 was trained to assign to input merchants classifications which indicate transactions that should be assigned to the merchant.

In another example, the system may use Siamese Neural Network 114 to assign classifications to the second resource access requests to generate rejection or acceptance reasons for a credit card, a loan or another financial instrument, where a justification is often necessary for approval or rejection decisions for reporting and compliance purposes. For example, the system may use Siamese Neural Network 114 to process newly received credit applications. Siamese Neural Network 114 has the ability to finely distinguish between the classifications and achieve a greater degree of nuance in considering reasons for rejecting credit applications. For example, where another model may mis-classify the reason for turning down a credit card application as lack of collateral, Siamese Neural Network 114 may accurately identify the reason to be an undesirable payment history of the user account.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for training machine learning models using differentiation, comprising: receiving a set of triplet inputs generated based on processing resource access requests using a first machine learning model, wherein each triplet input includes a resource access request, a correct reference classification of the resource access request, and an incorrect predicted classification of the resource access request output by the first machine learning model; initializing a first neural network, the first neural network comprising a first set of parameters; iteratively performing the following steps: generating a set of first distances by, for each triplet input in the set of triplet inputs, processing the resource access request in conjunction with the correct reference classification in the triplet input using the first neural network to obtain a first distance; generating a set of second distances by, for each triplet input in the set of triplet inputs, processing the resource access request in conjunction with the incorrect predicted classification in the triplet input using the first neural network to obtain a second distance; based on the set of first distances and the set of second distances, computing a loss metric for the first neural network; based on the loss metric, updating the first set of parameters for the first neural network; and processing second resource access requests, using the first neural network, to generate a second set of predicted classifications for the second resource access requests.
2. A method for training machine learning models using differentiation, comprising: receiving a set of triplet inputs, wherein each triplet input in the set of triplet inputs comprise a resource access request, a correct reference classification, and an incorrect classification; initializing a first machine learning model, the first machine learning model comprising a first set of parameters; iteratively performing the following steps: generating a set of first distances by, for each triplet input in the set of triplet inputs, processing the resource access request in conjunction with the correct reference classification in the triplet input using the first machine learning model to obtain a first distance; generating a set of second distances by, for each triplet input in the set of triplet inputs, processing the resource access request in conjunction with the incorrect classification in the triplet input using the first machine learning model to obtain a second distance; based on the set of first distances and the set of second distances, computing a loss metric for the first machine learning model; based on the loss metric, updating the first set of parameters for the first machine learning model; and processing second resource access requests, using the first machine learning model, to generate a second set of predicted classifications for the second resource access requests.
3. A method comprising: receiving a set of triplet inputs, wherein each triplet input in the set of triplet inputs comprises a resource access request, a correct reference classification, and an incorrect classification; initializing a first machine learning model, the first machine learning model comprising a first set of parameters; performing the following steps one or more times: generating a set of first distances by, for each triplet input in the set of triplet inputs, processing the resource access request in conjunction with the correct reference classification in the triplet input using the first machine learning model to obtain a first distance; generating a set of second distances by, for each triplet input in the set of triplet inputs, processing the resource access request in conjunction with the incorrect classification in the triplet input using the first machine learning model to obtain a second distance; based on the set of first distances and the set of second distances, computing a loss metric for the first machine learning model; based on the loss metric, updating the first set of parameters for the first machine learning model; and processing second resource access requests, using the first machine learning model, to generate a second set of predicted classifications for the second resource access requests.
4. The method of any one of the preceding embodiments, wherein generating the set of triplet inputs comprises: receiving a prototype machine learning model, wherein the prototype machine learning model is trained to predict an output classification for an input resource access request; processing a set of resource access requests using the prototype machine learning model to generate a set of predicted labels; comparing the set of predicted labels against a set of correct reference classifications corresponding to the set of resource access requests to generate a set of incorrect predicted classifications; and generating the set of triplet inputs based on the set of resource access requests, the set of correct reference classifications, and the set of incorrect predicted classifications.
5. The method of any one of the preceding embodiments, wherein generating the set of triplet inputs comprises: receiving a clustering machine learning model to embed a set of resource access requests and a set of classifications in an embedding space to generate a set of resource access request representations and a set of classification representations, wherein the embedding space is a real-valued space allowing resource access requests and classifications to be represented in real values; for each resource access request representation in the set of resource access request representations, identifying a closest classification representation and a second closest classification representation using the clustering machine learning model; and for each resource access request, generating a triplet input comprising the resource access request, a correct reference classification and an incorrect predicted classification, wherein the correct reference classification corresponds to the closest classification representation and the incorrect predicted classification corresponds to the second closest classification representation.
6. The method of any one of the preceding embodiments, wherein processing the resource access request in conjunction with the correct reference classification comprises: generating a feature vector based on the resource access request and the correct reference classification; and processing the feature vector using a Siamese neural network to generate a real number symbolizing the first distance between the resource access request and the correct reference classification.
7. The method of any one of the preceding embodiments, wherein computing the loss metric for the first machine learning model based on the set of first distances and the set of second distances comprises: based on a predetermined mathematical combination of the set of first distances and the set of second distances, computing a penalty value, wherein the penalty value is a real number; and generating the loss metric to comprise the penalty value, the set of first distances and the set of second distances.
8. The method of any one of the preceding embodiments, wherein based on the loss metric, updating the first set of parameters for the first machine learning model comprises: based on the penalty value and a gradient descent technique, adjusting the first set of parameters for the first machine learning model, wherein the first set of parameters are weights as biases for a Siamese neural network; based on the penalty value and the set of first distances, adjusting the first set of parameters for the first machine learning model; and based on the penalty value and the set of second distances, adjusting the first set of parameters for the first machine learning model.
9. The method of any one of the preceding embodiments, wherein each triplet input within the set of triplet inputs comprises a classification, a member resource access request, and a nonmember resource access request.
10. The method of any one of the preceding embodiments, wherein the first machine learning model is trained by iteratively performing the following steps: generating a set of first distances by, for each triplet input in the set of triplet inputs, processing the classification in conjunction with the member resource access request in the triplet input using the first machine learning model to obtain a first distance; generating a set of second distances by, for each triplet input in the set of triplet inputs, processing the classification in conjunction with the nonmember resource access request in the triplet input using the first machine learning model to obtain a second distance; based on the set of first distances and the set of second distances, computing a loss metric for the first machine learning model; and based on the loss metric, updating the first set of parameters for the first machine learning model.
11. The method of any one of the preceding embodiments, further comprising: in response to the loss metric for the first machine learning model exceeding a threshold value, ending the iterative performing to finalize the parameters for the first machine learning model.
12. The method of any one of the preceding embodiments, wherein each triplet input in the set of triplet inputs includes a resource access request, a correct reference classification of the resource access request, and an incorrect predicted classification of the resource access request output by a reference machine learning model, wherein the reference machine learning model was trained to process resource access requests.
13. One or more tangible, non-transitory, computer-readable media storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for training machine learning models using differentiation, comprising:
one or more processors; and
one or more non-transitory, computer-readable media comprising instructions that, when executed by the one or more processors, cause operations comprising:
receiving a set of triplet inputs generated based on processing resource access requests using a first machine learning model, wherein each triplet input includes a resource access request, a correct reference classification of the resource access request, and an incorrect predicted classification of the resource access request output by the first machine learning model;
initializing a first neural network, the first neural network comprising a first set of parameters;
iteratively performing the following steps:
generating a set of first distances by, for each triplet input in the set of triplet inputs, processing the resource access request in conjunction with the correct reference classification in the triplet input using the first neural network to obtain a first distance;
generating a set of second distances by, for each triplet input in the set of triplet inputs, processing the resource access request in conjunction with the incorrect predicted classification in the triplet input using the first neural network to obtain a second distance;
based on the set of first distances and the set of second distances, computing a loss metric for the first neural network;
based on the loss metric, updating the first set of parameters for the first neural network; and
processing second resource access requests, using the first neural network, to generate a second set of predicted classifications for the second resource access requests.

2. A method for training machine learning models using differentiation comprising:
receiving a set of triplet inputs, wherein each triplet input in the set of triplet inputs comprises a resource access request, a correct reference classification, and an incorrect classification;
initializing a first machine learning model, the first machine learning model comprising a first set of parameters;
iteratively performing the following steps:
generating a set of first distances by, for each triplet input in the set of triplet inputs, processing the resource access request in conjunction with the correct reference classification in the triplet input using the first machine learning model to obtain a first distance;
generating a set of second distances by, for each triplet input in the set of triplet inputs, processing the resource access request in conjunction with the incorrect classification in the triplet input using the first machine learning model to obtain a second distance;
based on the set of first distances and the set of second distances, computing a loss metric for the first machine learning model;
based on the loss metric, updating the first set of parameters for the first machine learning model; and
processing second resource access requests, using the first machine learning model, to generate a second set of predicted classifications for the second resource access requests.

3. The method of claim 2, wherein each triplet input in the set of triplet inputs includes a resource access request, a correct reference classification of the resource access request, and an incorrect predicted classification of the resource access request output by a reference machine learning model, wherein the reference machine learning model was trained to process resource access requests.

4. The method of claim 2, wherein generating the set of triplet inputs comprises:
receiving a prototype machine learning model, wherein the prototype machine learning model is trained to predict an output classification for an input resource access request;
processing a set of resource access requests using the prototype machine learning model to generate a set of predicted labels;
comparing the set of predicted labels against a set of correct reference classifications corresponding to the set of resource access requests to generate a set of incorrect predicted classifications; and
generating the set of triplet inputs based on the set of resource access requests, the set of correct reference classifications, and the set of incorrect predicted classifications.

5. The method of claim 2, wherein generating the set of triplet inputs comprises:
receiving a clustering machine learning model to embed a set of resource access requests and a set of classifications in an embedding space to generate a set of resource access request representations and a set of classification representations, wherein the embedding space is a real-valued space allowing resource access requests and classifications to be represented in real values;
for each resource access request representation in the set of resource access request representations, identifying a closest classification representation and a second closest classification representation using the clustering machine learning model; and
for each resource access request, generating a triplet input comprising the resource access request, a correct reference classification and an incorrect predicted classification, wherein the correct reference classification corresponds to the closest classification representation and the incorrect predicted classification corresponds to the second closest classification representation.

6. The method of claim 2, wherein processing the resource access request in conjunction with the correct reference classification comprises:
generating a feature vector based on the resource access request and the correct reference classification; and
processing the feature vector using a Siamese neural network to generate a real number symbolizing the first distance between the resource access request and the correct reference classification.

7. The method of claim 2, wherein computing the loss metric for the first machine learning model based on the set of first distances and the set of second distances comprises:
based on a predetermined mathematical combination of the set of first distances and the set of second distances, computing a penalty value, wherein the penalty value is a real number; and
generating the loss metric to comprise the penalty value, the set of first distances and the set of second distances.

8. The method of claim 7, wherein based on the loss metric, updating the first set of parameters for the first machine learning model comprises:
based on the penalty value and a gradient descent technique, adjusting the first set of parameters for the first machine learning model, wherein the first set of parameters are weights as biases for a Siamese neural network;
based on the penalty value and the set of first distances, adjusting the first set of parameters for the first machine learning model; and
based on the penalty value and the set of second distances, adjusting the first set of parameters for the first machine learning model.

9. The method of claim 2, wherein each triplet input within the set of triplet inputs comprises a classification, a member resource access request, and a nonmember resource access request.

10. The method of claim 9, wherein the first machine learning model is trained by iteratively performing the following steps:
generating a set of first distances by, for each triplet input in the set of triplet inputs, processing the classification in conjunction with the member resource access request in the triplet input using the first machine learning model to obtain a first distance;
generating a set of second distances by, for each triplet input in the set of triplet inputs, processing the classification in conjunction with the nonmember resource access request in the triplet input using the first machine learning model to obtain a second distance;
based on the set of first distances and the set of second distances, computing a loss metric for the first machine learning model; and
based on the loss metric, updating the first set of parameters for the first machine learning model.

11. The method of claim 2, further comprising:
in response to the loss metric for the first machine learning model exceeding a threshold value, ending the iterative performing to finalize the parameters for the first machine learning model.

12. One or more non-transitory computer-readable media comprising instructions that, when executed by one or more processors, cause operations comprising:
receiving a set of triplet inputs, wherein each triplet input in the set of triplet inputs comprises a resource access request, a correct reference classification, and an incorrect classification;
initializing a first machine learning model, the first machine learning model comprising a first set of parameters;
performing the following steps one or more times:
generating a set of first distances by, for each triplet input in the set of triplet inputs, processing the resource access request in conjunction with the correct reference classification in the triplet input using the first machine learning model to obtain a first distance;
generating a set of second distances by, for each triplet input in the set of triplet inputs, processing the resource access request in conjunction with the incorrect classification in the triplet input using the first machine learning model to obtain a second distance;
based on the set of first distances and the set of second distances, computing a loss metric for the first machine learning model;
based on the loss metric, updating the first set of parameters for the first machine learning model; and
processing second resource access requests, using the first machine learning model, to generate a second set of predicted classifications for the second resource access requests.

13. The one or more non-transitory computer-readable media of claim 12, wherein each triplet input in the set of triplet inputs includes a resource access request, a correct reference classification of the resource access request, and an incorrect predicted classification of the resource access request output by a reference machine learning model, wherein the reference machine learning model was trained to process resource access requests.

14. The one or more non-transitory computer-readable media of claim 12, wherein generating the set of triplet inputs comprises:
receiving a prototype machine learning model, wherein the prototype machine learning model is trained to predict an output classification for an input resource access request;
processing a set of resource access requests using the prototype machine learning model to generate a set of predicted labels;
comparing the set of predicted labels against a set of correct reference classifications corresponding to the set of resource access requests to generate a set of incorrect predicted classifications; and
generating the set of triplet inputs based on the set of resource access requests, the set of correct reference classifications, and the set of incorrect predicted classifications.

15. The one or more non-transitory computer-readable media of claim 12, wherein generating the set of triplet inputs comprises:
receiving a clustering machine learning model to embed a set of resource access requests and a set of classifications in an embedding space to generate a set of resource access request representations and a set of classification representations, wherein the embedding space is a real-valued space allowing resource access requests and classifications to be represented in real values;
for each resource access request representation in the set of resource access request representations, identifying a closest classification representation and a second closest classification representation using the clustering machine learning model; and
for each resource access request, generating a triplet input comprising the resource access request, a correct reference classification and an incorrect predicted classification, wherein the correct reference classification corresponds to the closest classification representation and the incorrect predicted classification corresponds to the second closest classification representation.

16. The one or more non-transitory computer-readable media of claim 12, wherein processing the resource access request in conjunction with the correct reference classification comprises:
generating a feature vector based on the resource access request and the correct reference classification; and
processing the feature vector using a Siamese neural network to generate a real number symbolizing the first distance between the resource access request and the correct reference classification.

17. The one or more non-transitory computer-readable media of claim 12, wherein computing the loss metric for the first machine learning model based on the set of first distances and the set of second distances comprises:
based on a predetermined mathematical combination of the set of first distances and the set of second distances, computing a penalty value, wherein the penalty value is a real number; and
generating the loss metric to comprise the penalty value, the set of first distances and the set of second distances.

18. The one or more non-transitory computer-readable media of claim 17, wherein based on the loss metric, updating the first set of parameters for the first machine learning model comprises:
based on the penalty value and a gradient descent technique, adjusting the first set of parameters for the first machine learning model, wherein the first set of parameters are weights as biases for a Siamese neural network;
based on the penalty value and the set of first distances, adjusting the first set of parameters for the first machine learning model; and
based on the penalty value and the set of second distances, adjusting the first set of parameters for the first machine learning model.

19. The one or more non-transitory computer-readable media of claim 12, wherein each triplet input within the set of triplet inputs comprises a classification, a member resource access request, and a nonmember resource access request.

20. The one or more non-transitory computer-readable media of claim 19, wherein the first machine learning model is trained by iteratively performing the following steps:
generating a set of first distances by, for each triplet input in the set of triplet inputs, processing the classification in conjunction with the member resource access request in the triplet input using the first machine learning model to obtain a first distance;
generating a set of second distances by, for each triplet input in the set of triplet inputs, processing the classification in conjunction with the nonmember resource access request in the triplet input using the first machine learning model to obtain a second distance;
based on the set of first distances and the set of second distances, computing a loss metric for the first machine learning model; and
based on the loss metric, updating the first set of parameters for the first machine learning model.
